(19) United States
(12) Patent Application Publication
(10) Pub. No.: US 2011/0153441 A1
(43) Pub. Date: Jun. 23, 2011

(54) Systems and Methods for Authorizing Use of Validly Sold Merchandise

(76) Inventors: Merrill Brooks Smith, Atlanta, GA (US); Phillip Craig Graves, Atlanta, GA (US); Phil M. Chakiris, Atlanta, GA (US); David J. Etling, Atlanta, GA (US)

(21) Appl. No.: 12/645,956

(22) Filed: Dec. 23, 2009

(51) Int. Cl. G06Q 10/00; G06Q 40/00; G06Q 30/00; G06F 17/30; G06F 15/16

(52) U.S. Cl. 705/21; 705/39; 705/24; 707/769; 709/206; 707/E17.014; 705/26.25; 705/27.1

(57) ABSTRACT

The invention is generally directed to a method of managing the activation and use of a specific merchandise, facilitated between at least a retailer that sells the specific merchandise, a customer that purchases the specific merchandise, and a central processor that authorizes activation and use of the specific merchandise. The method includes the steps of receiving an indicia that uniquely identifies the specific merchandise, and an activation code associated with the merchandise that will allow the merchandise to properly function; storing the indicia of the specific merchandise and the activation code; receiving a confirmation of a valid purchase transaction of the specific merchandise, the confirmation of valid sale comprising the indicia of the specific merchandise; determining the activation code associated with the specific merchandise; and providing the activation code associated with the specific merchandise to the customer.

The present application hereby incorporates by reference in its entirety U.S. patent application Ser. No. 11/672,204, filed on Feb. 7, 2007 (now issued U.S. Pat. No. 7,437,328) which is a continuation-in-part of U.S. patent application Ser. No. 10/739,301, filed on Dec. 19, 2003 (now Issued U.S. Pat. No. 7,328,190).

### FIELD OF THE INVENTION

This invention is generally directed to the sale, authorization, and use of various merchandise sold from a point-of-sale. Specifically, the invention is directed to confirming that merchandise is validly sold at a point-of-sale, and providing to the purchaser an indicia necessary to authorize use of the merchandise.

### BACKGROUND OF THE INVENTION

Theft of merchandise is a typical problem throughout the retail industry. Merchandise may be stolen by various people, including the employees of a retailer. Retailer losses from theft are not insignificant: In 2007 retailers lost an estimated 15 billion to shoplifting. (See 2008 Jack Hayes International, Inc. Survey). The U.S. Chamber of Commerce estimates that theft by employees costs American companies $20 billion to 40 billion a year. Accordingly, theft is a significant problem for which numerous solutions have been posed.

The majority of solutions to prevent and deter theft are directed to preventing merchandise from leaving the retailer's premises. These methods include surveillance (i.e. closed-circuit cameras, security employees) and physical controls (i.e. electronic labels, magnetic devices, and ink packets).

However, these methods have at least two (2) drawbacks. First, neither surveillance nor physical controls are tied into the point-of-sale terminal. In other words, both methods still require trust in employees to either observe or remove the physical control only when the item is purchased. Additionally, neither method prevents use of the product once it is stolen. In other words, once a thief bypasses the retailer's security system, the merchandise may be used as if it was validly and legally obtained.

Moreover, the only link between the security and the sale of the merchandise is the employee, a link which is often untrustworthy. Neither surveillance nor physical controls prevent theft tactics such as “lost” inventory, undercharging at the point of sale, not charging for the appropriate product—if for any product at all—at the point of sale, or improper removal from stock rooms or shipments.

Second, both surveillance and physical controls generally only restrict the use of the merchandise until is has left the premises of the retailer. While ink tags theoretically prevent theft due to the risk of spoilage of the stolen merchandise, ink tags can be removed either by a clever thief or by a dishonest employee.

Accordingly, there is a need for a direct connection between the use of merchandise and a valid sale. There is a need for a means to prevent ill-gotten merchandise from being used by dishonest employees or thieves.

### SUMMARY OF THE INVENTION

Aspects of the invention include a method of managing the activation and use of a specific merchandise, facilitated between at least a retailer that sells the specific merchandise, a customer that purchases the specific merchandise, and a central processor that authorizes activation and use of the specific merchandise. The method includes the steps of receiving an indicia that uniquely identifies the specific merchandise, and an activation code associated with the merchandise that will allow the merchandise to properly function; storing the indicia of the specific merchandise and the activation code; receiving a confirmation of a valid purchase transaction of the specific merchandise, the confirmation of valid sale comprising the indicia of the specific merchandise; determining the activation code associated with the specific merchandise; and providing the activation code associated with the specific merchandise to the customer.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### BRIEF DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1A depicts a system of authorizing validly sold merchandise, transacted between a manufacturer/provider of goods or services, a retailer, and a customer, in accordance with some embodiments of the present invention.

FIG. 1B depicts a flow chart illustrating a method of authorizing validly sold merchandise, transacted between a manufacturer/provider of goods or services, a retailer, and a customer, in accordance with some embodiments of the present invention.

FIG. 2A depicts a system of authorizing validly sold merchandise, transacted between a manufacturer/provider of goods or services, a central processor, a retailer, and a customer, in accordance with some embodiments of the present invention.

FIG. 2B depicts a flow chart illustrating a method of authorizing validly sold merchandise, transacted between a manufacturer/provider of goods or services, a central processor, a retailer, and a customer, in accordance with some embodiments of the present invention.

FIG. 3A depicts a system of authorizing validly sold merchandise, transacted between a manufacturer/provider of goods or services, a central processor, a retailer, and a customer, in accordance with some embodiments of the present invention.

FIG. 4 depicts a flow-chart illustrating a method for authorizing the use of merchandise from the perspective of the central processor, in accordance with some embodiments of the invention.

FIG. 5 depicts a flow-chart illustrating a method for authorizing the use of merchandise from the perspective of the retailer, in accordance with some embodiments of the invention.

FIG. 6 depicts a flow-chart illustrating a method for authorizing the use of merchandise from the perspective of the customer, in accordance with some embodiments of the invention.

### DETAILED DESCRIPTION OF THE INVENTION

Reference will now be made in detail to embodiments of the invention, examples of which are illustrated in the accompanying drawings.

In general, the present invention is directed to systems and methods for preventing the unauthorized use of merchandise that was not validly sold. Specifically, merchandise may be disabled until a proper authorization code is entered, the code only being provided to the customer following confirmation of a valid purchase transaction.

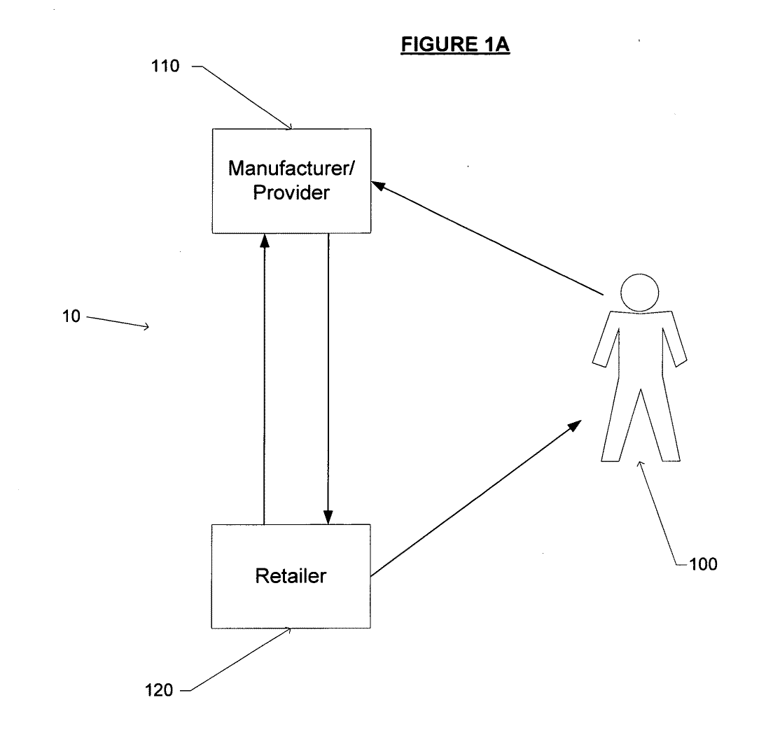

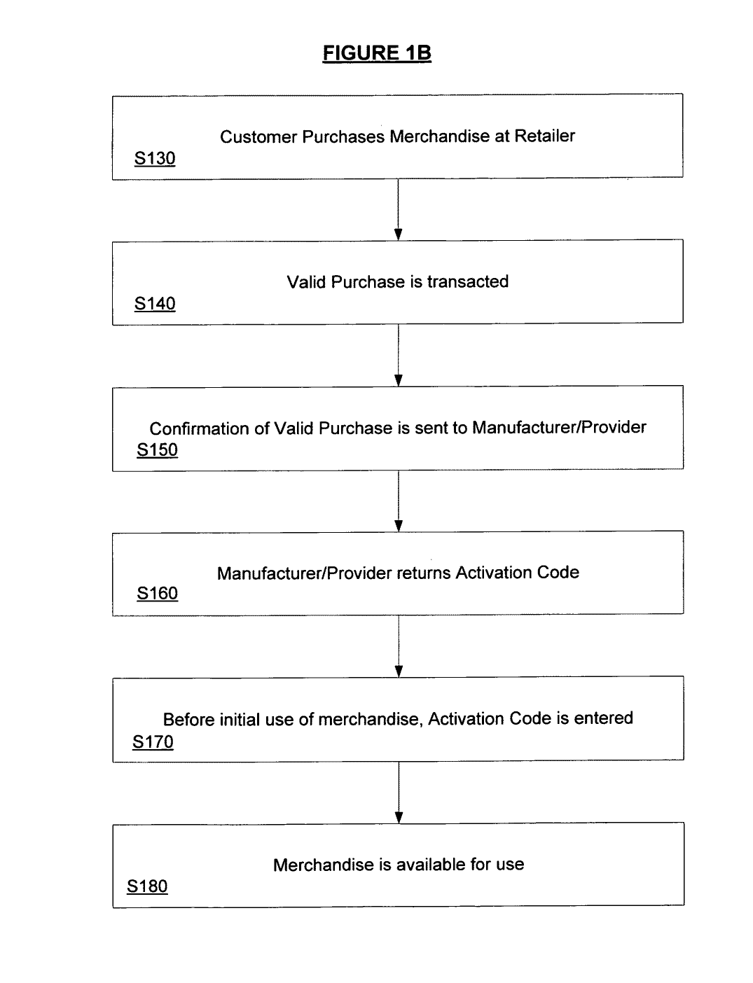

With reference to FIG. 1, a system 10 in accordance with some embodiments of the present invention will now be discussed. The system depicted in FIG. 1 utilizes a customer 100, a manufacturer/provider of goods or services (“manufacturer/provider”) 110, and a retailer 120.

The manufacturer/provider 110 may provide a variety of goods or services to the retailer 120, including but not limited to electronic devices, housewares, software, digital media, telecommunication service, television service, internet service, etc. For ease of discussion, the merchandise sold by the manufacturer/provider may be referred to herein as a television. However, the merchandise can take any form, and may be merchandise that has communicative properties (for example, mobile devices, televisions, computers, etc.), merchandise that has a user interface (for example, televisions, coffee makers, global positioning systems, etc.), and merchandise that does not have a user interface, but has utilitarian inputs (for example, a toaster oven with an on/off switch, timer, and temperature control).

The retailer 120 may be any type of retailer, operating a traditional brick-and-mortar store (such as Wal-Mart stores), operating with an on-line retail presence (such as www.Amazon.com), operating through a physical or digital catalog (such as L.L. Bean), or any such combination. Moreover, the a distributor who distributes good for resale may also be considered a retailer. In general, the term “retailer” is intended to capture any party that sells or distributes goods to another party.

The customer 100 may be an individual, a corporation, an entity that plans to resell any goods or services obtained, or any combination thereof.

With reference to FIG. 1B, a method in accordance with some embodiments of the present invention will now be discussed. At step S130, a customer 100 may present merchandise at a retailer's point of sale (POS) for purchase. A valid purchase of the merchandise may be transacted at the POS at step S140. For traditional brick-and-mortar stores, the POS may be the check-out register. For online retailers, the POS may be the customer's computer. For catalog orders, the POS may be the customer's telephone. In general, the retailer's POS may be any device or tool that assists in the purchase transaction between the customer and retailer that results in title to the merchandise changing hands from the retailer to the customer.

At step S150, a confirmation of the valid purchase transaction may be sent to the manufacturer/provider, who at step S160 may return an activation code. The activation code may be provided to the customer. Before initial use of the merchandise, the customer must enter the activation code (step S170). At step S180, upon receipt of the activation code, the merchandise will be available for use.

An example of this may be the purchase of a television from a retailer. Televisions shipped to a retailer may be disabled by the manufacturer/provider. Each television may be associated with a specific activation code that will enable the television to function properly. A customer selects a television at the store and brings the television to the check-out register. Once the customer has provided the appropriate price (including any applicable fees, taxes, surcharges, etc.), the point of sale device may communicate with the manufacturer/provider and inform the manufacturer/provider that the specific television has been sold in a valid purchase transaction.

The manufacturer/provider may then determine (with reference to a database or listing of activation codes and specific merchandise) the appropriate activation code and may provide this activation code to the customer. The activation code may be provided to the customer via the POS device (for example by printing the code on the receipt) or by any other means. For example, the activation code may be send to the customer's mobile device, email, or even mailed via traditional postal mail to the customer's address.

Upon attempting to use the television, the television may require the customer to enter the activation code. Once the customer enters the activation code, the television will function properly. The customer may only have a set number of chances to enter the appropriate activation code before the television's functions are locked and a call the manufacturer/provider may be required.

There are numerous deviations from this process that are contemplated by the inventors. For example, merchandise without communicative properties may have the activation code pre-loaded into the merchandise. Merchandise with communicative properties may be disabled, but may rely upon a confirmation with the database of the manufacturer/provider before allowing use. Additionally, the activation code may be a numeric, alpha-numeric or other such code entered into a user interface of the merchandise. Alternatively, the activation code may be a series of commands or prompts. For example, if the merchandise is a toaster, the activation code may be something along the lines of “turn the toast knob to full dark toast; turn the timer to 12 minutes; set the temperature to 300 degrees; turn the power on.” Additionally, the activation code may be provided to the merchandise via a number of methods, including user input, connection to a computer (for example, via USB ports), RFID communication with an activation card provided at the POS, the reading of a bar code or magnetic stripe, or the insertion of a memory card or chip.

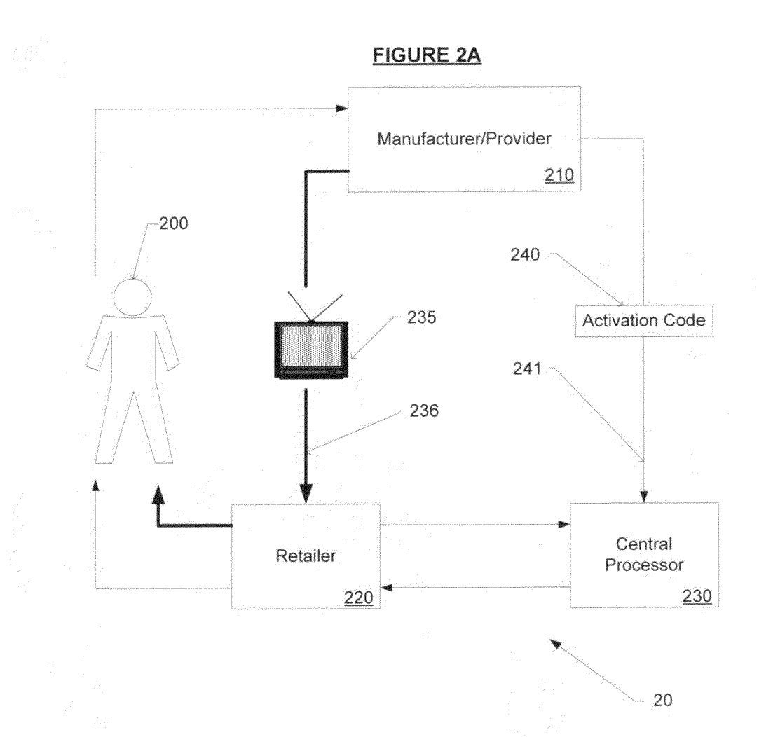

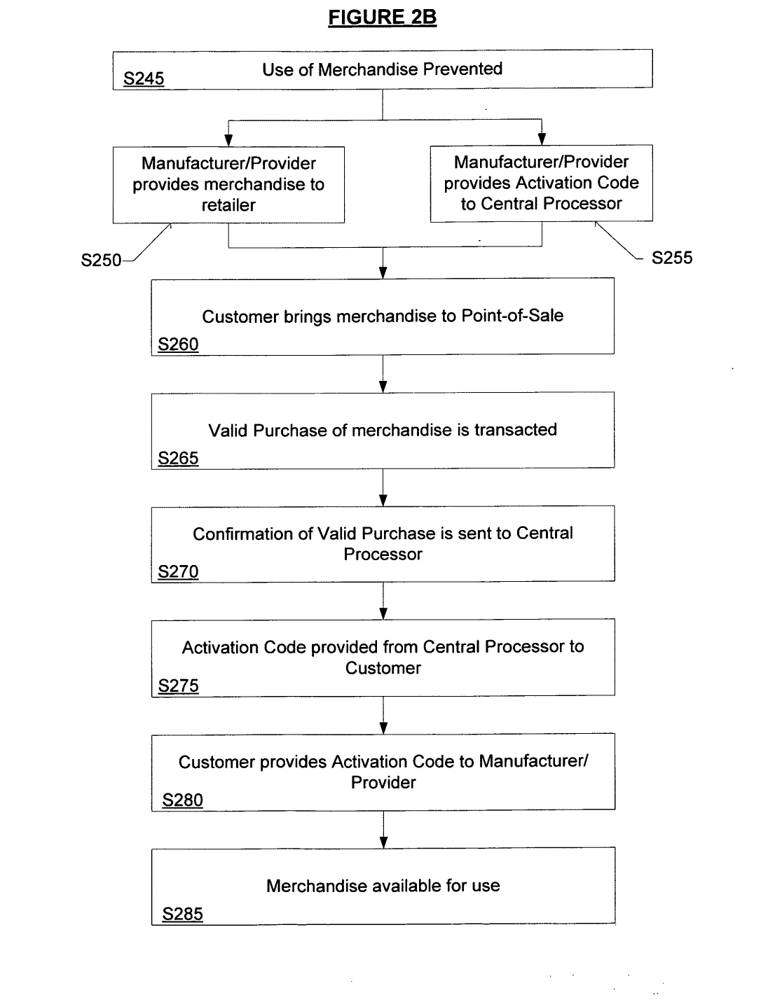

With reference to FIG. 2, a system in accordance with some embodiments of the present invention will be discussed. The system 20 in FIG. 2 depicts a slightly modified process, which includes a central processor 230, in addition to a customer 200, manufacturer/provider 210, and retailer 220. The central processor 230 may an unrelated third party, or may be a processor maintained by either the retailer 220 or the manufacturer/provider 210. The central processor 230 may be utilized so that a separate entity or unit handles the activation code process.

FIG. 2A illustrates a specific piece of merchandise 235, and its distribution channel 236, as well as a specific activation code 240 associated with the specific piece of merchandise 235 and the distribution channel of the specific activation code 241. Please note that the FIG. 2A illustrates a system in which the merchandise 235 is associated with the activation code 240 at the manufacturer/provider 210. It is anticipated that this association may be created and maintained by any other party, such as the central processor 230 or the retailer 220. For example, upon receiving inventory of numerous pieces of merchandise, the retailer 220 may assign specific activation codes required for use of each piece of merchandise. Alternatively, a manufacturer/provider 210 or a retailer 220 may provide to a central processor 230 information identifying specific merchandise (for example, a serial number or any other predetermined identifier) and the central processor 230 may assign activation codes for each specific piece of merchandise.

One of the pertinent parts of the invention is the fact that the customer 200 does not receive the activation code 240 until after a valid purchase transaction is confirmed. In the exemplary embodiment illustrated in FIG. 2A, the manufacturer/provider 210 may provide the specific merchandise 235 to the retailer 220, and the activation code 240 associated with the specific merchandise to the central processor 230. During the purchase transaction of the specific merchandise 235, the central processor 230 may provide the activation code 240 to the retailer 220, who may in turn provide the activation code 240 to the customer 200. Again, the retailer 220 may be omitted from this step, and the activation code 240 may be passed directly from the central processor 230 to the customer 200, for example by way of a communication to a mobile device of a customer. At this point, the customer 200 is equipped with both the specific merchandise 235 and the activation code 240 needed to use the merchandise 235.

FIG. 2B depicts a flow-chart of this method of activation of merchandise in accordance with some embodiments of the present invention. At step S245, the use of merchandise is prevented. This disablement of the merchandise may occur at the manufacturer/provider, retailer, or central processor. This step S245 may occur before the manufacturer/provider distributes the merchandise to the retailer (as illustrated in FIG. 2B) or may occur at the retailer or central processor following such distribution.

At step S250, the manufacturer/provider may provide specific merchandise to the retailer, and at step S255 the manufacturer/provider may provide the activation code for the specific merchandise to the central processor. At step S260, the customer may bring the specific merchandise to the point of sale, and at step S265 a valid purchase transaction may be conducted. A valid purchase transaction is a transaction in which the proper price for the merchandise is paid by the customer. In such a purchase transaction, in return for the proper price, the title to the merchandise is transferred to the customer.

A confirmation of a valid purchase transaction is provided to the central processor at step S270. In response, the central processor may pass the activation code for the specific merchandise to the customer at step S275. This information may be passed to the customer via the retailer or the point of sale device (such as printing the code on a receipt, or by storing the code in a machine readable indicia), or may be passed directly to the customer from the central processor (for example, by communicating with the customer's mobile device, email account, postal mail, etc. Alternatively, the retailer may provide an indicia of the activation code—for example, a unique or semi-unique identifier. The customer may use this identifier to obtain the activation code (for example, by entering the identifier into a specific website, interacting with an IVR system, or interacting with a customer service representative), or the identifier may include the activation code embedded therein (for example, the activation code may be several digits embedded into a larger number, may be a particular checksum or number arrived at by applying a specific algorithm to the identifier, or may be determined mathematically using the predetermined identifier).

The customer is now equipped to use the specific merchandise. Upon initial use of the specific merchandise, the customer may provide the activation code at step S280. As discussed above, this activation code may be provided to the merchandise in a number of methods (non-limiting examples include via a user interface, various prompts, commands, controls, entry of a memory card, having the merchandise read machine readable information, connection to a computer or a network of any kind, etc.).

If the proper activation code is entered, the specific merchandise will be available for use at step S285. It is contemplated that the proper code may confirmed in many ways. For example, the specific merchandise may be pre-loaded with the specific activation code. Alternatively, if the specific merchandise has communicative abilities, it may reach out to a remote database (maintained by any party, for example by the manufacturer/provider, retailer, or central processor) to confirm the proper activation code was received.

If an improper activation code is received, the specific merchandise will be remain disabled. It is anticipated that if the improper activation code is entered more than a specified amount of times, the specific merchandise may be permanently disabled until the customer contacts the party that disabled the specific merchandise (for example, the manufacturer/provider, retailer, or central processor) and may receive over-ride instructions.

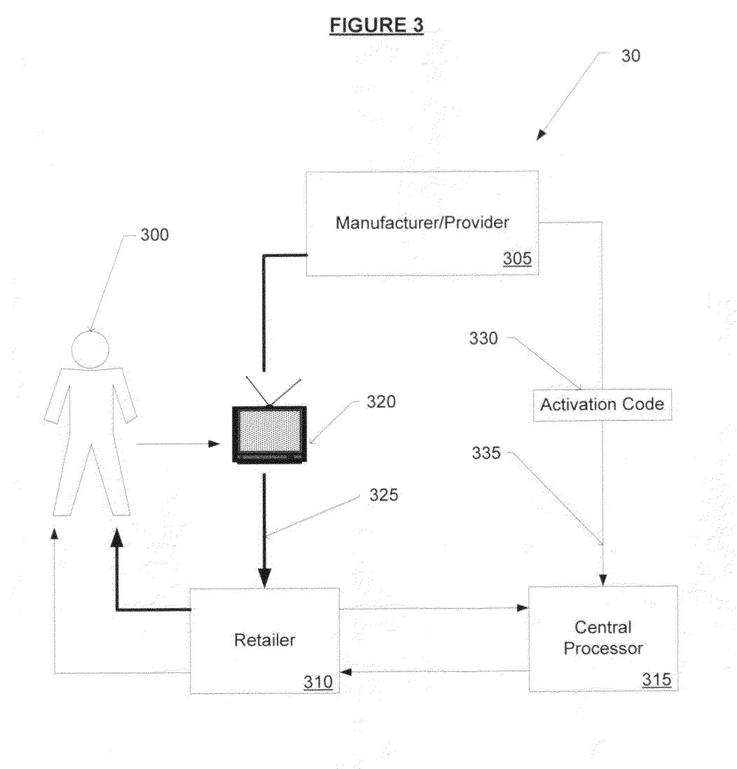

FIG. 3 depicts a system 30 in accordance with some embodiments of the present invention. FIG. 3 shows a system 30 similar to that of FIG. 2A, except that the once the manufacturer/provider 305 sends the specific merchandise 320 to the retailer 310, and the activation code 330 to the central processor 315, the involvement of the manufacturer/provider 305 in the activation process is unnecessary. Instead, the activation code 330 follows pathway 335, from the manufacturer/retailer 305 to the central processor 315; from the central processor 315 to the customer 300 by way of the retailer 310. The customer 300 then provides the activation code 330 to the specific merchandise itself 320 in order to activate and use. The specific merchandise 320 may follow the pathway 325 from the manufacturer/provider 305 to the retailer 310 to the customer 300.

Again, deviations from the specific system and method illustrated in exemplary FIG. 3 are contemplated. The merchandise may be disabled at any point during its travels through the chain of commerce. The activation code may be predetermined by the manufacturer/retailer 305, or may be created and determined by the entity disabling the merchandise. The activation code may be provided to the customer from the manufacturer/provider 305, the retailer 310, the central processor 315, or any combination thereof (for example, from the central processor 315 through a point of sale device at the retailer 310).

Additionally, the customer 300 may never receive the activation code. Instead, the activation code could be provided by the retailer at the point of sale. This could occur via an input from the retailer or from the retailer's point of sale device. For example, the specific merchandise may be disabled until it receives a specific activation code, which may be received directly into the merchandise via radio frequency identification (RFID) communications. The retailer may receive the activation code at the point of sale, and may pass the activation code directly to the merchandise via an RFID transmission. Alternatively, the activation code (or another indicator of a valid sale) may be sent, along with an identification of the specific merchandise, to a manufacturer/provider (or a retailer, or a central processor). When the specific merchandise is initially turned on, the specific merchandise may automatically communicate with the manufacturer/provider (or the retailer or central processor), the valid purchase may be determined, and the specific merchandise may be available for use.

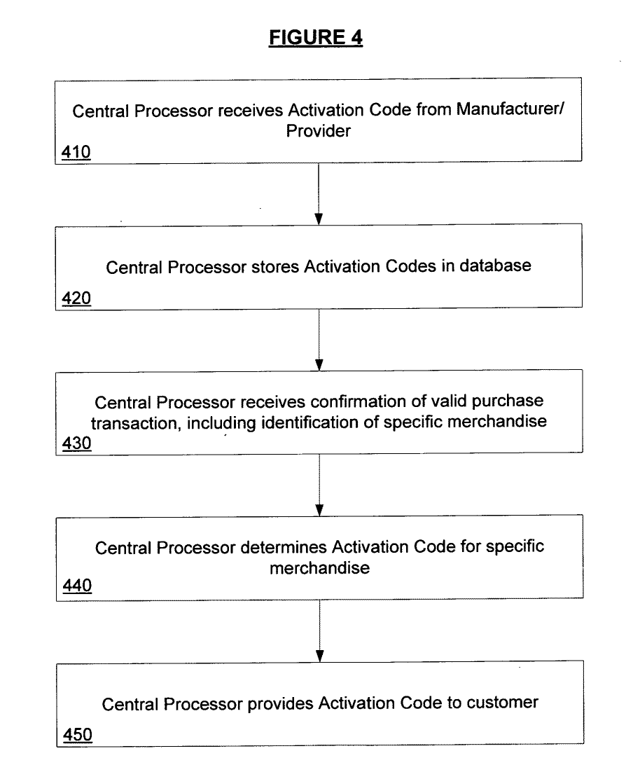

With reference to FIG. 4, a method of authorizing the use of specific merchandise—from the prospective of the central processor—in accordance with some embodiments of the present invention will now be discussed. At step S410, the central processor receives at least one activation code from the manufacturer/provider, as well as information indicating which activation code is associated with which specific merchandise. For example, the central processor may receive a file for use in a relational database that identifies the specific merchandise (for example, by serial number or another predetermined identifier) and identifies the activation code pre-associated with the specific merchandise. The specific merchandise may be disabled at the manufacturer/provider.

At step S420 the central processor stores the information received from the manufacturer/provider in a record or database of some kind.

At step S430, the central processor may receive a confirmation of a valid purchase transaction. The confirmation may contain information sufficient to identify the specific merchandise purchased at the point of sale.

At step S440, the central processor may determine the activation code associated with the specific merchandise. The central processor may make this determination by consulting a look-up table, relational database, or by any other means generally known in the art.

At step S450, the central processor may provide the activation code associated with the specific merchandise to the customer. This may be provided to the customer through the retailer, or may be provided directly to the customer.

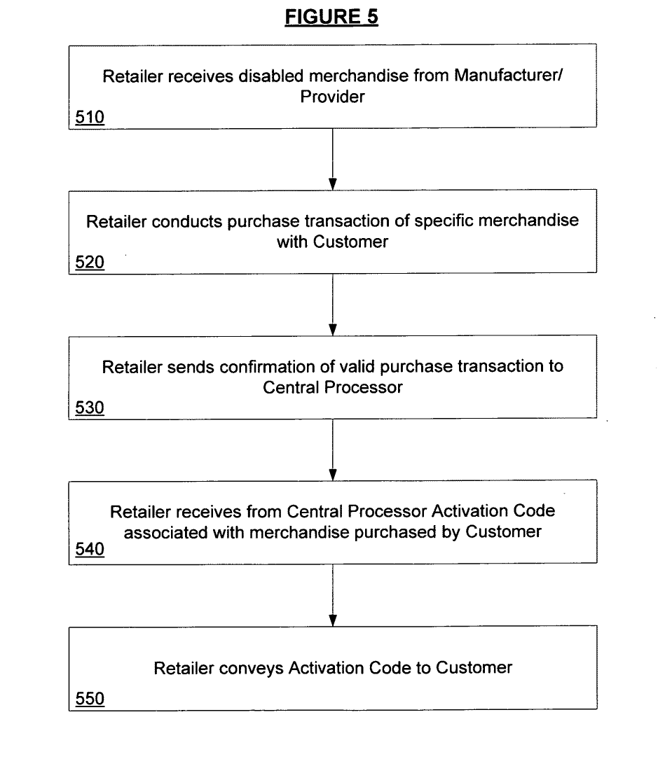

With reference to FIG. 5, a method for authorizing the use of merchandise from the perspective of the retailer, in accordance with some embodiments of the invention, will now be discussed.

At step S510, the retailer may receive merchandise from a manufacturer/provider. The merchandise may be provided by a distributor or affiliate of the manufacturer/provider. The merchandise may be disabled at the manufacturer/provider, or the retailer may disable the merchandise upon receipt of the merchandise.

At step S520, the retailer may conduct a purchase transaction of specific merchandise with a customer. The purchase transaction may comprise information sufficient to identify the specific merchandise.

At step S530, the retailer may send to the central processor a confirmation of a valid purchase transaction. The confirmation of valid purchase transaction may comprise information sufficient to identify the specific merchandise validly sold at the point of sale.

At step S540, the retailer may receive an activation code associated with the specific merchandise from the central processor.

At step S550, the retailer may convey the activation code to the customer. The retailer may convey this activation code to the customer in any number of ways, including but not limited to, verbally informing the customer, printing the activation code on a receipt, printing the activation code in a machine readable medium (for example, a bar code, magnetic stripe, or memory device), etc.

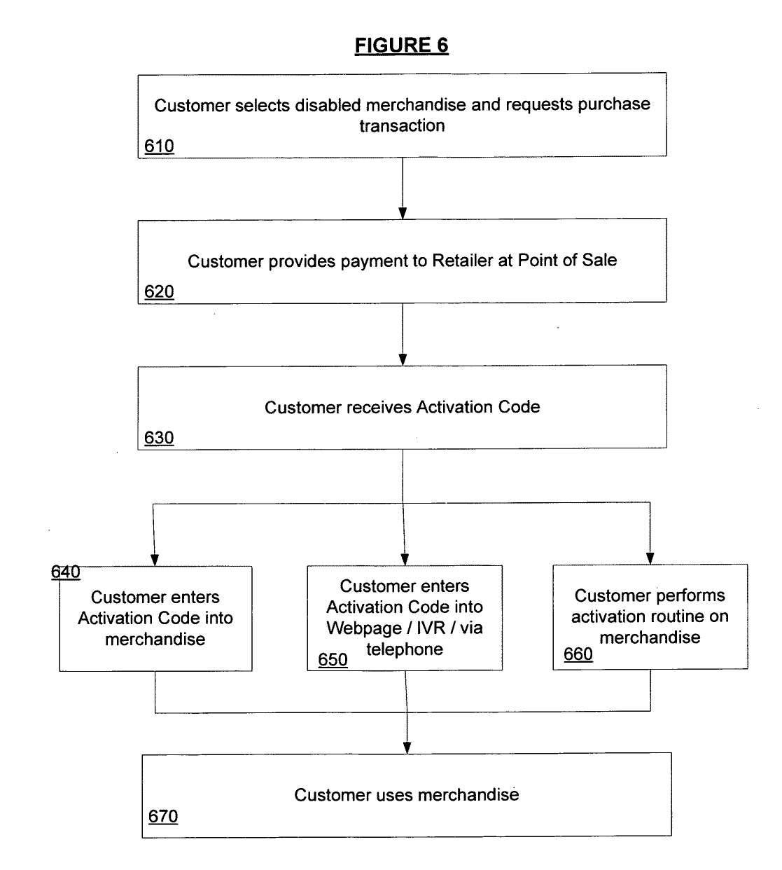

With reference to FIG. 6 a method for authorizing the use of merchandise from the perspective of the customer, in accordance with some embodiments of the invention, will now be discussed. At step S610, the customer may select specific merchandise from a retailer, and request a purchase transaction for the specific merchandise.

At step S620, the customer may provide payment to the retailer (plus any applicable fees or taxes) in order to purchase the specific merchandise.

At step S630, the customer may receive the activation code for the specific merchandise. The customer may receive this activation code directly from the central processor, manufacturer/provider, or by or through the retailer.

The customer may then enter the activation code in a number of manners, depending on the nature of the specific merchandise. At step S640, the customer may enter the activation code into a user interface of the specific merchandise. Alternatively, at step S650, the customer may enter the activation code into a webpage or other interface with a service associated with the specific merchandise. Alternatively, at step S660, the customer may perform an activation routine necessary to activate specific merchandise that does not include a typical user interface (for example, a toaster oven that does not include a user interface keypad or the like).

At step S670, if the proper activation code has been received by the specific merchandise, the customer may use the specific merchandise.

It will be apparent to those skilled in the art that various modifications and variations can be made in the method, manufacture, configuration, and/or use of the present invention without departing from the scope or spirit of the invention. For example, while the goods discussed herein were physical goods, the systems and methods disclosed herein are equally applicable to digital goods, such as software or digital media, as well as services.

Moreover, the customer may pass the activation code, not to the specific merchandise itself, but rather to another service or entity that works with the specific merchandise. For example, if the specific merchandise is a television, after the television is connected to a specific network (for example, a satellite television network), the customer may provide the activation code to the satellite television network (for example, by calling a telephone number, email, a specific web page or internet interface, etc.). The satellite television network may then communicate the code to the television, thereby enabling use. This specific methodology may be particularly useful for targeted promotional programs; a television may be sold to a customer at a reduced rate if the television is used only with a particular service, for example DirecTV.

Additionally, to improve security an activation code received by the customer may need to be exchanged for an separate activation code. For example, at the point of sale the customer may receive an indicia of a valid sale in lieu of the activation code. The activation code for use with the specific merchandise may be obtained by exchanging the indicia of a valid sale using a telephone call, interactive voice response (IVR) unit, web page, or any other such communication technique.

In some embodiments, pre-determined criteria may exist to which the price paid by the customer is compared. For example, a forty-two inch plasma television may have the predetermined criteria of a minimum price of $500. Provided the purchase transaction is for at least $500, the activation code may be provided to the customer. Additional criteria may exist, including but not limited to, requiring the customer to sign up for a specific service, requiring the customer to purchase additional items or merchandise, requiring the customer to keep the merchandise or service for a set period of time, etc.

1. A method of managing the activation and use of a specific merchandise, facilitated between a manufacturer that manufactured the specific merchandise, a retailer that sells the specific merchandise, a customer that purchases the specific merchandise, and a central processor that authorizes activation and use of the specific merchandise, the method comprising:
receiving at the central processor:
an indicia of the specific merchandise, sufficient to uniquely identify the specific merchandise; and
an activation code associated with the specific merchandise, the activation code required to allow the specific merchandise to properly function;
storing at the central processor the indicia of the specific merchandise and the activation code;
receiving at the central processor a confirmation of a valid purchase transaction of the specific merchandise from the retailer, the confirmation of valid sale comprising the indicia of the specific merchandise;
determining at the central processor the activation code associated with the specific merchandise;
providing the activation code associated with the specific merchandise to the customer.

2. The method of claim 1, wherein the step of providing the activation code associated with the specific merchandise to the customer comprises sending the activation code to the retailer, and the retailer in turn providing the activation code to the customer.

3. The method of claim 2, wherein the retailer provides the activation code to the customer by printing the activation code on a receipt.

4. The method of claim 2, wherein the retailer provides the activation code to the customer on a printed document unrelated to the purchase transaction.

5. The method of claim 1, wherein the step of providing the activation code associated with the specific merchandise to the customer comprises sending the activation code to a mobile device of the customer.

6. The method of claim 1, wherein the step of providing the activation code associated with the specific merchandise to the customer comprises sending the activation code to an email account of the customer.

7. The method of claim 1, wherein the step of providing the activation code associated with the specific merchandise to the customer comprises entering the activation code into the specific merchandise at the retailer.

8. The method of claim 1, wherein the step of determining at the central processor the activation code associated with the specific merchandise comprises looking up the indicia of the specific merchandise in a database and identifying the associated activation code.

9. The method of claim 1, wherein the step of determining at the central processor the activation code associated with the specific merchandise comprises applying a mathematical function or algorithm to the indicia of the specific merchandise.

10. The method of claim 1, wherein the confirmation of valid purchase transaction of the specific merchandise is received from a point-of-sale device of a retailer.

11. The method of claim 1, wherein the activation code is provided by the central processor only after the retailer has received funds necessary for the purchase transaction.

12. The method of claim 1, wherein the activation code is provided by the central processor only after the retailer confirms that the funds necessary for the purchase transaction have cleared.

13. The method of claim 1, wherein the confirmation of the valid purchase transaction further comprises a price paid by the customer for the specific merchandise.

14. The method of claim 13, wherein the price paid by the customer for the specific merchandise must meet minimum criteria before the central processor provides the activation code to the customer.

15. The method of claim 1, wherein the manufacturer disabled the specific merchandise prior to sending the specific merchandise to the retailer for sale.

16. The method of claim 1, wherein the retailer disables the specific merchandise before presenting the specific merchandise for sale.

17. The method of claim 1, wherein the retailer is an on-line retailer, and wherein the activation code is provided to a computer of the customer.

18. The method of claim 1, wherein the retailer is a catalog based retailer, and wherein the activation code is provided to the customer over a telephone of the customer.

19. A method of managing the activation and use of a specific merchandise purchased by a customer, facilitated by a retailer that sells the specific merchandise, the method comprising:
storing at the retailer:
an indicia of the specific merchandise, sufficient to uniquely identify the specific merchandise; and
an activation code associated with the specific merchandise, the activation code required to allow the specific merchandise to properly function;
following a valid purchase transaction at a point-of-sale of the retailer, determining the activation code associated with the specific merchandise;
providing the activation code associated with the specific merchandise to the customer.

20. The method of claim 19, wherein the retailer provides the activation code to the customer by printing the activation code on a receipt.

21. The method of claim 19, wherein the retailer provides the activation code to the customer on a printed document unrelated to the purchase transaction.

22. The method of claim 19, wherein the step of providing the activation code associated with the specific merchandise to the customer comprises entering the activation code into the specific merchandise at the retailer.

23. The method of claim 19, wherein the activation code is provided to the customer only after the retailer has received funds necessary for the purchase transaction.

24. The method of claim 19, wherein the activation code is provided by to the customer only after the retailer confirms that the funds necessary for the purchase transaction have cleared.

25. The method of claim 19, wherein a price paid by the customer for the specific merchandise must meet minimum criteria before the retailer provides the activation code to the customer.

26. The method of claim 19, wherein the manufacturer disabled the specific merchandise prior to sending the specific merchandise to the retailer for sale.

27. The method of claim 19, wherein the retailer disables the specific merchandise before presenting the specific merchandise for sale.

28. A method of managing the activation and use of a specific merchandise, facilitated between a retailer that sells the specific merchandise, a customer that purchases the specific merchandise, and a central processor that authorizes activation and use of the specific merchandise, the method comprising:
selecting, by the customer, the specific merchandise from the retailer;
conducting, by the customer, a valid purchase transaction for the specific merchandise, wherein the customer provides payment for the specific merchandise;
receiving, by the customer, an activation code associated with the specific merchandise;
entering, by the customer, the activation code into the specific merchandise;
using, by the customer, the specific merchandise.

29. The method of claim 28, wherein the retailer is an on-line retailer and the customer selects and conducts the valid purchase transaction via a webpage.

30. The method of claim 28, wherein the valid purchase transaction comprises confirmation that the payment has been actually received by the retailer.

31. The method of claim 28, wherein the customer receives the activation code at a point-of-sale of the retailer.

32. The method of claim 31, wherein the customer receives the activation code printed on a receipt related to the valid purchase transaction.

33. The method of claim 31, wherein the point-of-sale of the retailer comprises a specific webpage of the retailer where the valid purchase transaction is conducted by the customer.

34. The method of claim 28, wherein the customer receives the activation code at a mobile device of the customer.

35. The method of claim 28, wherein the customer receives the activation code at an email account of the customer.

36. The method of claim 28, wherein the valid purchase transaction requires a payment for the specific merchandise that meets pre-determined criteria.

37. A method of managing the activation and use of a specific merchandise, facilitated between a manufacturer that manufacturers the specific merchandise, a retailer that sells the specific merchandise, and a customer that purchases the specific merchandise, the method comprising:
identifying at the manufacturer the specific merchandise with an indicia;
providing the specific merchandise from the manufacturer to the retailer for sale to the customer;
receiving at the manufacturer an indication that a valid sale has been transacted between the customer and the retailer, the indication comprising the indicia of the specific merchandise;
providing from the manufacturer to the customer an activation code that enables use of the specific merchandise.

38. The method of claim 37, wherein the activation code is provided to the customer from the manufacturer by providing the activation code to the retailer who in turn provides the activation code to the customer.

39. The method of claim 37, wherein the indication of valid sale is received from the merchant.

40. The method of claim 37, wherein the indication of valid sale is received from the customer.
